(19) United States
(12) Patent Application Publication
(10) Pub. No.: US 2015/0331226 A1
(43) Pub. Date: Nov. 19, 2015

(54) MOBILE MICROSCOPY DEVICE BEING ABLE TO TAKE IMAGES IN DIFFERENT WAVELENGTHS (MULTISPECTRAL)

(71) Applicant: GRIMED SAGLIK HIZMETLERI VE BILGISAYAR ÜRÜNLERI SANAYI TICARET LIMITED, Istanbul (TR)

(72) Inventor: Osman ESKI, Instanbul (TR)

(21) Appl. No.: 14/410,067

(22) PCT Filed: Jun. 18, 2013
(86) PCT No.: PCT/TR2013/000187

§ 371 Date: Dec. 20, 2014

(30) Foreign Application Priority Data
Jun. 21, 2012 (TR) 2012/07236
Dec. 24, 2012 (TR) 2012/15168

(51) Int. Cl. G02B 21/00; G02B 21/06; G02B 21/26; G02B 21/02

(52) U.S. Cl. CPC G02B 21/0008; G02B 21/025; G02B 21/06; G02B 21/26

(57) ABSTRACT

A mobile microscopy device that can be integrated onto mobile imaging devices and mobile phones, and take images in different wavelengths to be used in various fields where microscopic investigation is needed, characterized in that it has a lens module placed into an imaging head and having at least one lens that carries out different magnification rates as needed, a filter module having at least one filter device to filler out reflected light being sent in different wavelengths so as to be sensed by the imaging sensors, and a led module having at least one led to send light beams in different wavelengths.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention is related to a microscopy device being able to take, record and share data and images especially in the field of medical diagnostics (eye, gynecology, dermatology, ear, nose and throat, cosmetic, forensic medicine) and all areas where microscopic investigation is needed and being able to be integrated to mobile phones and other mobile imaging devices and can take images in different wavelengths (multispectral).

2. Description of Related Art Including Information Disclosed Under 37 CFR 1.97 and 37 CFR 1.98.

There are devices being able to take multispectral images, used for diagnosis, identification and microscopic investigation. But these devices are not mobile (portable) due to their production methods. They cannot take data fast and instantly. The necessary investigations could be obtained in specific centers and with the availability of some technological capabilities. In the places and conditions where technological abilities are not available, necessary samples are taken and sent to related centers.

It was not possible to integrate multispectral microscopy devices, which means having ability to take images in various nanometers, into mobile phones or mobile imaging devices owing to used methods and production types in the prior art. But it is possible to take images in desired definition by using different leds, lenses and filters and appropriate apparatus according to field of use.

There are systems integrated into mobile imaging devices and mobile phones only for dermatology in the prior art. Furthermore there are methods for using mobile imaging devices as microscopy device. But in both systems, it is very restricted with the field of use of the acquired image and present abilities for only some devices in determined numbers.

In the patent application, US2006/0132774, a device regarding to dermoscopy is put forward. But here it is only for a single object and for instant investigation.

In US2006/0139640, a single system having a similar purpose and properties is disclosed.

In CN202003084 U, It has been tried to put forward recording and investigating image obtained by integration of microscopy device with a mobile phone. But it should not be achieved mobility and easiness of use, therefore only restricted investigations carried out in limited fields.

Filters are added in front of Camera CCD or CMOSs (image sensors) in multispectral image systems. Single lenses are used as banded to these filters. With this method, only limited images could be obtained and limited field of use was provided. Furthermore image acquisition was tried by using a number of leds sending light beams in different wavelengths.

It is necessary that multispectral image should be put forward for using in various fields in mobile imaging systems and for obtaining data having desired clearance, there should be used appropriate filters and leds being able to send lights in different wavelengths and they should be placed in right locations. This system should be adapted to a mobile phone or a mobile imaging system appropriately.

It does not exist such a system that is integrated into mobile phones and mobile imaging systems, and provides image gathering ability in a wide field of use thanks to desired different wavelengths and can be adapted to all mobile imaging systems in the prior art technique.

### BRIEF SUMMARY OF THE INVENTION

An object of the present invention is to provide a multispectral (to take images μ different nanometers) microscopy device to be used in the fields where microscopic investigation is needed and to combine necessary elements for obtaining images in accordance with the field and to integrate mobile phones or mobile imaging systems having appropriate technology.

### BRIEF DESCRIPTION OF THE DRAWINGS

FIG. 1: A front view of the device main body of the present invention

FIG. 2a: Main body side view

FIG. 2b: Main body bottom view of the present invention.

FIG. 3a, 3a1: A front sectional view showing placement detail of the imaging head of the present invention.

FIG. 3b,3c,3d: A front presentational view of the lens module, filter module, led module and filter in front of led located on the body of the imaging device of the present invention.

FIG. 4,4a: Adjustment apparatus for appropriate field of use located in front of the main body and imaging head of the present invention.

FIG. 5a: A representative view of a mobile phone

FIG. 5b,5d: A side view of integrated position of the main body of the present invention and the mobile phone.

FIG. 5c: A presentational view of an intermediate connection member providing integrated structure for camera and main body imaging head which are positioned differently onto different models of mobile phones and imaging systems having different structure.

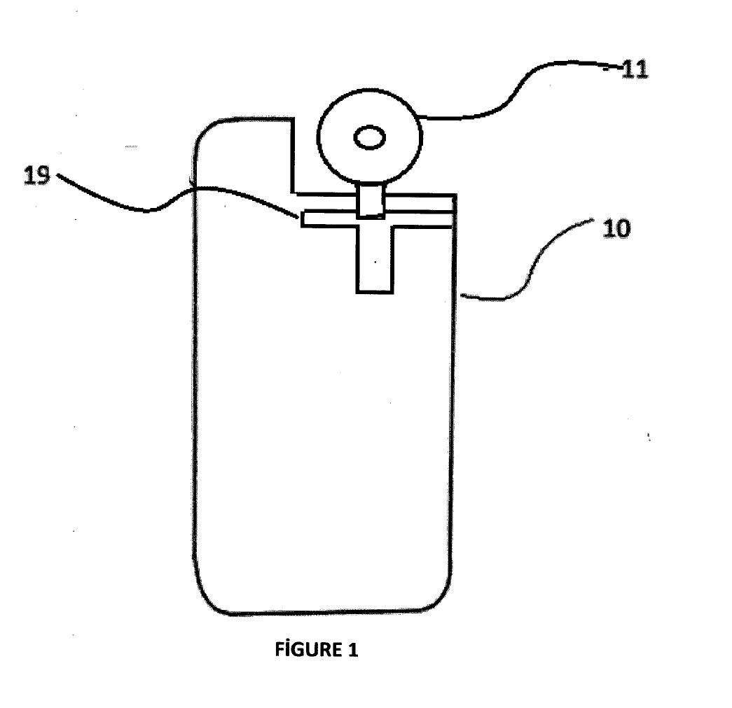

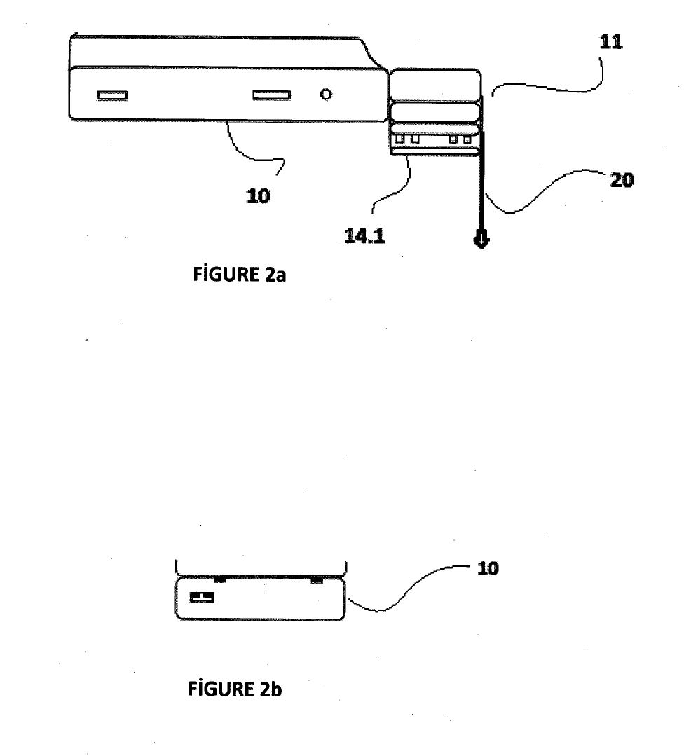

### REFERENCE NUMERALS

10. Main body
11. Imaging head
12. Lens module
12.1 Lens slot
13 Filter module
13.1 Filter nest
14 Led module
14.1 Polarization filter in front of Led
14.2 Led nest
15 Mobile phone
16. Camera
17. Intermediate member
18 Apparatuses
18.1 Apparatus 1
18.2 Apparatus 2
18.3 Apparatus 3
18.4 Apparatus 4
18.5 Apparatus 5
18.6 External energy input
19. Adjustment slide
20. Distance adjustment bar

### DETAILED DESCRIPTION OF THE INVENTION

The present invention is related to a multispectral microscopy device for providing images having different nanometers in mobile devices by putting forward an appropriate combination of camera (16) on a mobile phone (15) with lenses (12), filters (13), leds (14) which are positioned within imaging head (11) according to field of use.

To put forward microscopic investigation, different magnification rates are needed according to field of use. This can be only provided by different lenses. This condition can be hold in the prior art without mobility but only fixed or with the existence of various apparatus and devices. They are not portable in the prior technique as connected onto the mobile devices.

Furthermore imaging head (11) can be used directly without needing to use main body (10). Imaging head has a plug in/plug out property.

The cameras (16) of the existed mobile phones (15) and imaging systems can only take pictures as macro. Macro taking is not enough to put a desired result and for medical and microscopic investigations.

A lens module (12) positioned into the imaging head (11) of the present invention can carry out different magnification rates as being desired and needed.

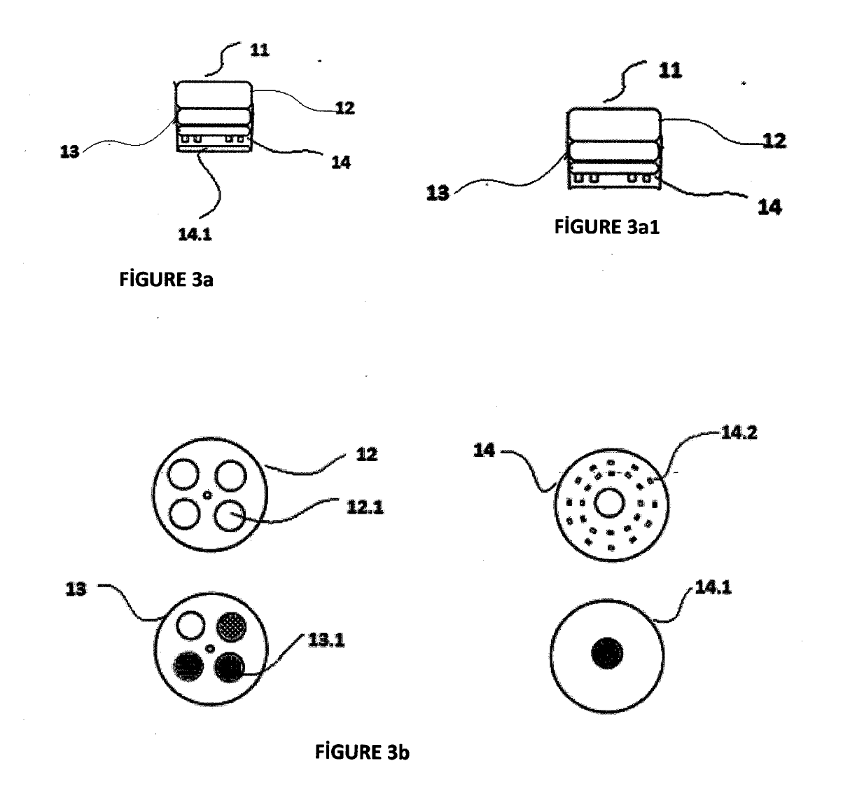

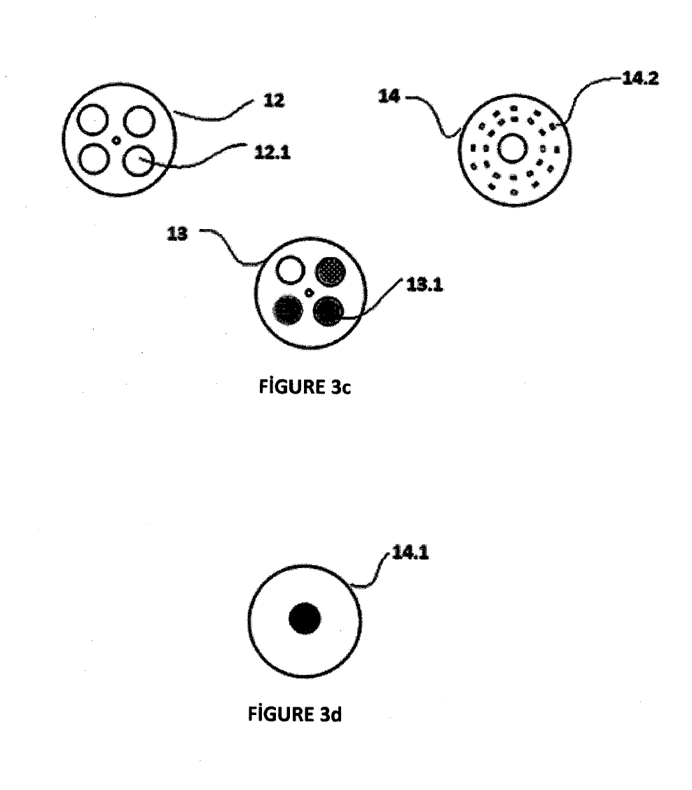

Owing to said lens module (12) given in FIG. 3b-3c, the lenses being to provide different magnification rates is positioned onto a lens nest (12-1). It is possible to use in a number of field by the lens module (12) having lenses, which are to provide said magnification rate, by existing it more than one on a single body.

Furthermore said lens module (12) can be plugged in and plugged out and said lenses are changeable. Lenses are positioned to provide right magnification rates according to field of use.

It is provided that it can be changeable circularly by turning on. Said turning on operation can be carried out by manually over said main body (10) or automatically by computer programs and using mobile phones (15) in accordance with the system. Furthermore due to step motors turning operation may be carried out.

Lenses to provide different magnification levels are mounted circularly and in desired amount on said lens module (12). Lenses provide different magnification rates as coming into alignment with the camera of said imaging device. Availability of using camera lens directly is provided for the purpose of macro taking. Macro taking can be possible by the lens of imaging device camera directly thanks to an empty lens slot (12-1). In addition, by having a cartridge design multiple usage is also possible.

Filters presented in FIG. 3b are placed on a filter module (13), image sensors (CCD, CMOS) or in front of the lens module (12) for taking image in different wavelengths. Filters provide filtering of light beams in different wavelengths which are sent through the region where an image would like to be taken as they are returning back to the camera (16) again. Reflection of lights sent in different wavelengths is sensed back as being filtered by filters so as to be sensed by sensors (cad, cmos). Therefore desired multispectral image is obtained on mobile imaging systems and mobile phones.

Said filter module (13) is provided as replaceable circularly and by turning on as seen in FIG. 3b. The turning operation can be carried out by manually on the main body (10) or automatically with using compatible mobile phones (15), with computer program and with step motors.

Furthermore by establishing communication helping with the Wireless connections positioned on the main body (10), necessary adjustments and data transaction is provided.

Said filter module (13) is designed as cartridge so as to be replaceable. There are filters more then one on a single body.

To obtain different wavelengths, light rays in different wavelengths should be sent. For this purpose leds in different wavelengths should be used. The led module (14) that can be seen in FIG. 3b is emerged. Leds on the led module are aligned and radiated in different forms (straight, transverse, parallel etc). Each led group send lights in different wavelength.

Leds are located circularly over led nest (14.2). Adjustment at the radiation is provided as, manual or automatic.

The polarization filter (14.1) in front of the led consists of at least one filter. It provides polarized images as positioned in front of leds having white light beam radiation.

It is achieved to get multispectral images, to carry out microscobical investigations by positioning lenses, filters and leds in front of the camera (16) of imaging devices or mobile phones (15) and by doing this placement as interchangeable. These components are located in front of the camera (16) on the imaging head (11).

Imaging head (11) is positioned in front of the camera (16) of a mobile phone. On one hand they should be aligned on the same plane, on the other hand mobile phones or imaging devices having various models have cameras in different points. For this reason, a main body is designed in accordance with the model and in compatible form.

The imaging head (11) can be mounted on the main body (10) externally. The imaging head on the main body (10) is fixed so as to be aligned on the same plane with the camera using attachments methods such as nail looking or magnet.

The cameras on the mobile phones and imaging systems are fixed in general. Changing their places is not possible.

To provide alignment of the imaging head (11) and the camera (16) to the same point, on one hand it can be possible by plug in/out methods as disclosed above, on the other hand it is also possible with an adjustment slide (19) and the main body compatible with the cameras having different positions. Thanks to slide (19) the mobile phone and the imaging head of the body are aligned to as to be centered.

While the camera (16) and the head (11) could be brought together as desired by the main body (10), additional technical requirements such as additional power supply for supplying necessary energy to the all components and some connections wired or wireless could be met on the main body.

These modules on the imaging head (11) have plug in/out property. Getting different magnification levels and putting fields of use forward are provided. Some modules are also plugged in as being cartridge or tablet or to be plugged out if needed.

Filter (13), led (14) and lens (12) modules can be produced as multiple or single In accordance with the necessity. As it is possible to use single led to four leds, filters are also located in different numbers. Fields of use determines the lens, led and fillers to be placed.

Furthermore It is also possible to obtain different magnification levels by placing lens onto the filter nest (13.1) of the filter module (13).

Filters should be placed before leds, in placement order. But filter is to be placed between camera and lens or between lens and leds. As going from the camera of the imaging device towards the outside, filter should be placed before leds.

With a purpose of combining filter, lens and led modules in appropriate locations they are formed in circular and replaceable and increasable in numbers according to need.

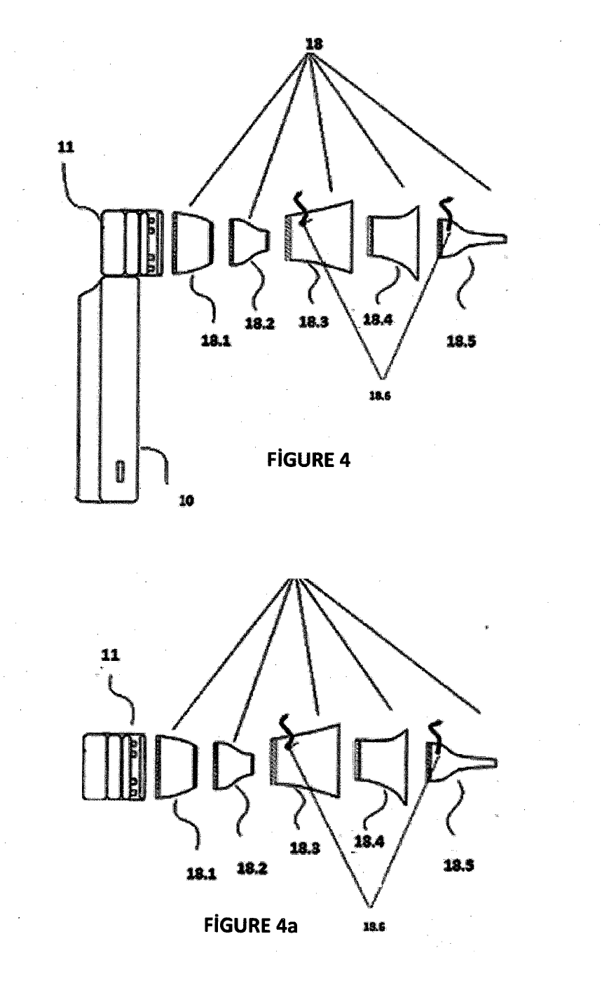

Apparatuses (18), which are compatible with the lenses in FIG. 4, are placed in front of the imaging head on the main body (10) by means of nail locking or magnet. It is possible to change apparatus according to field of use.

Apparatuses are used for various duties; for instance apparatus 1 (18.1) for dermatology, apparatus 2 (18.2) for investigating narrow areas such as nail bottom, apparatus 3 for lam investigations, apparatus 4 (18.4) for investigating inside of eye, apparatus 5 (18.5) for investigations for inside of ear and nose. Apparatuses are applied for only one use. Apparatuses can be mounted by means of magnet or nail locking for glug in/out property.

Distance adjustment bar (20) is for adjusting the distance between area to investigate and the device. It is used to determine the necessary distance for taking clear image depending on the lenses, and to choose appropriate lens.

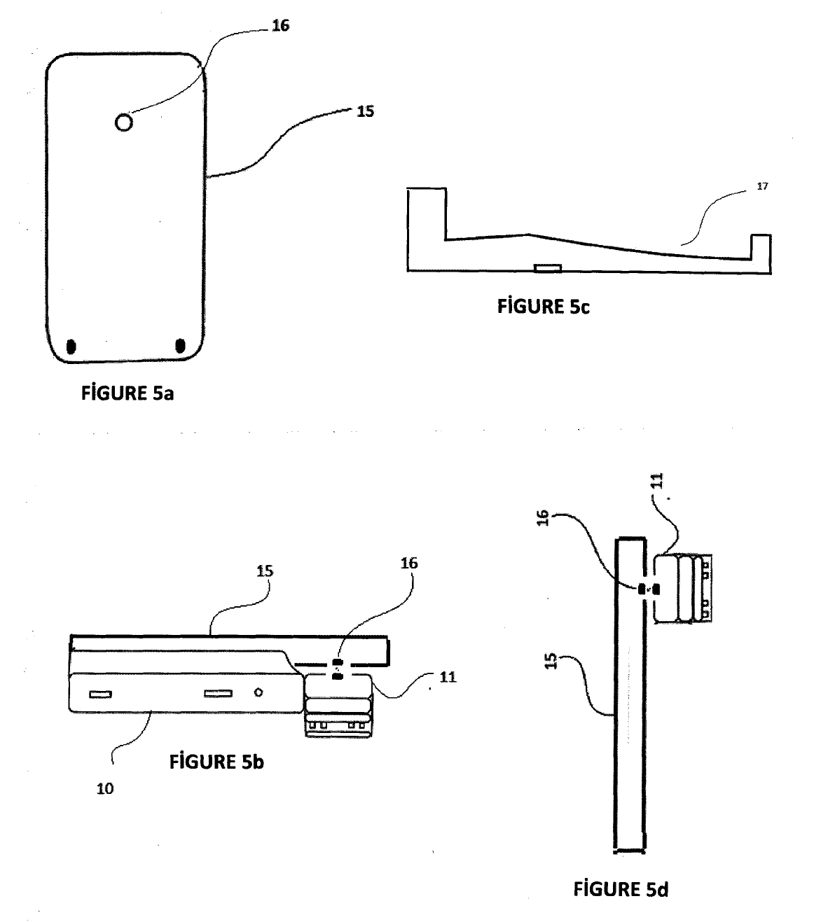

It is provided to adapt in any kind of mobile imaging device by an interval connection member (17) being shown in FIG. 5c. Furthermore a power source is placed in said interval connection member.

By the connection member, it can be possible to design only a single main body for adapting to all different and new model imaging devices and therefore in place of the main body, by changing only the interval connection member (17), the main body is possible to be mounted on a mobile imaging device.

A rechargeable power supply is positioned on the main body. As the power supply of the mobile imaging device, which the main body is connected, the power supply unit, which is positioned on it, may also be used.

If the main body is used, the imaging head (11) would also meet energy demand from the main body, and if the main body is not used, it could get the energy from the device which it is connected.

1. A mobile microscopy device that can be integrated onto mobile imaging devices and mobile phones, and can take images in different wavelengths to be used in various fields where microscopic investigation is needed, characterized in that it comprises a lens module being placed into an imaging head and having at least one lens that carries out different magnification rates as needed, a filter module having at least one filter device to filter out reflected light being sent in different wavelengths so as to be sensed by the imaging sensors, and a led module having at least one led to send light beams in different wavelengths.

2. An imaging head according to claim 1, characterized in that; it comprises a lens module carrying out different magnification rates, a filter module having at least one filter device to filler out reflected light sent in different wavelengths so as to be sensed by the imaging sensors, a led module having at least one led to send light beams in different wavelengths and a polarization filters in front of the led to provide taking lightwave to a specified plane as coming before the leds radiating white lights.

3. An imaging head according to claim 1, wherein the modules located inside are to have a plug in/out property.

4. A filter module according to claim 1, wherein different magnification rates are provided by installing different lenses and placing in front of the lens module.

5. A lens module according to claim 1, wherein it is replaceable, turnable and in circular form to place multiple lenses.

6. A lens module according to claim 1, wherein it comprises at least one empty lens slot for taking macro images as using camera lens directly.

7. A filter module according to claim, wherein it is replaceable, turnable and in circular form to place multiple filters.

8. A filter module according to claim 1, wherein it is placed before the led module when it is sorted from camera to outside within said imaging head.

9. A led module according to claim 1, wherein it is replaceable, turnable and in circular form to place multiple leds.

10. A led module according to claim 1, wherein it is grouped and placed in order such as straight, diagonal and in parallel to radiate light in different wavelengths.

11. A main body according to claim 1, wherein it comprises an adjustment slide providing movements laterally and downwardly, to get aligned the camera and the imaging head.

12. A main body according to claim 1, wherein it comprises a battery slot to meet additional power requirement.

13. A polarization filter in front of the led, according to claim 1, wherein it takes the lightwave to a specified plane by placing in front of the leds radiating white light.
